(19) United States
(12) Patent Application Publication
(10) Pub. No.: US 2003/0155890 A1
(43) Pub. Date: Aug. 21, 2003

(54) Current supply device and electrical apparatus

(76) Inventors: Stefan Roepke, Leinfelden (DE); Rainer Glauning, Aichtal-Groetzingen (DE); Volker Bosch, Stuttgart (DE)

Correspondence Address: STRIKER, STRIKER & STENBY, 103 East Neck Road, Huntington, NY, 11743, US

(21) Appl. No.: 10/365,330

(22) Filed: Feb. 11, 2003

(30) Foreign Application Priority Data
Feb. 16, 2002 (DE) 102 06 485.7

(51) Int. Cl. H02J 7/00

(52) U.S. Cl. 320/114

(57) ABSTRACT

A current supply device for an electrical appliance formed as a battery-operated power tool has an electrical energy storage, a protection circuit for the energy storage, and a switching element for switching off the protection circuit.

### BACKGROUND OF THE INVENTION

The present invention relates to a current supply device for an electrical apparatus, in particular for a battery operated tool.

In battery-operated electrical appliances, such as for example a power drill or battery-operated screwdriver, there is a problem that conventional batteries have a technically required self-discharging and therefore are frequently no longer usable after a long storage time.

Furthermore, batteries without selfdischarging are known, which can be used after a long storage. Such selfdischarge-free batteries require however an electrical protection circuit in normal operation, which again consume current. During a long storage of a batter-operated electrical appliance with such a selfdischarge-free battery, the battery is discharged by the current consumption of the protection circuit, so that the battery after a long storage is also no longer usable.

### SUMMARY OF THE INVENTION

Accordingly, it is an object of the present invention to provide a current supply device and an electrical appliance which avoid the disadvantages of the prior art.

More particularly, it is an object of the present invention to provide a protection circuit for a selfdisharge-free electrical energy storage, such as for example the above mentioned battery, which is turned off during a long storage, so that the energy storage is not discharged by the current consumption of the protection circuit.

The present invention deals with an electrical energy storage which is not limited to the above mentioned selfdischarge-free battery. Moreover, the invention can be realizable also with a non-rechargeable battery which require a protection circuit. Furthermore, the term “energy storage” within the spirit of the invention can deal with other types of energy storage, such as for example fuel cells.

For turning off the protection circuit during a long storage, a switching element is provided, which is connected directly or with the protection circuit.

In accordance with an embodiment of the present invention, the switching element can be arranged preferably between the protection circuit and the energy storage, in order to separate the protection circuit during a long storage from the energy storage and thereby to prevent undesirable discharge of the energy storage by the protection circuit.

In accordance with another embodiment of the present invention, the current supply of the protection circuit is carried out indirectly through a control circuit of the associated electrical appliance. The protection circuit as a rule is not connected directly with the energy storage, so that no separation of the protection circuit from the energy storage is necessary. In this variant the switching element is connected with the control circuit of the electrical appliance to switch off thereby indirectly the protection circuit.

The term “switching element” is not limited only to a manually operated circuit, but also includes for example a relays, power transistors and time-controlled switching elements. Also, an automatic circuit can be combined with a manual circuit. For example it is possible that the switching off of the protection circuit is performed automatically after a predetermined time interval of the inactivity with time control, while to the contrary the turning off of the protective circuit or the complete electrical compliance is performed manually.

In accordance with the variant of the invention, the protection circuit is turned off automatically with time control, when the electrical appliance is not used over a predetermined time interval. For this purpose a time switch clock is provided which acts on a switching element and switches off the protection circuit in this way when the predetermined time interval of the inactivity is covered. For example the time switch clock has a control input which is connected with the control circuit of the electrical appliance, so that the time switch clock during a use of the electrical apparatus is set back. Before the resumption of the use of the electrical appliance the user must activate the switching element to again activate the protection circuit.

In accordance with a preferable embodiment of the invention, the energy storage and the protection circuit are components of an energy storage module, for example formed as a battery pack, and has a joint housing.

The switching element can be integrated in the energy storage module, so that the switching element in normal operational condition must be preferably activatable from outside, so that the user of an electrical appliance can turn off the protection circuit for a longer storage without removal of the energy storage module from the electrical appliance.

There is however a possibility that the switching element can be arranged outside of the energy storage module, for example in the electrical appliance itself. This provides the advantage that the switching element can be placed in the housing of the electrical appliance in ergonomically optimal manner. In this embodiment the protection circuit draws its current preferably from the control circuit of the electrical appliance so that the switching element for the control circuit makes possible a switching off of the protection circuit.

The electrical appliance in accordance with the present invention further has preferably a receiving compartment for the energy storage module. Terminal contacts can be preferably arranged in the receiving compartment and on the energy storage module to provide an electrical connection between the control circuit located in the electrical appliance and the protection circuit located in the energy storage module.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing an electrical appliance with a current supply device in accordance with the present invention;

FIG. 2 is a view showing an alternative embodiment of an electrical appliance in accordance with the present invention; and

FIG. 3 is a view showing an embodiment of a battery pack for electrical appliances in accordance with the present invention.

### DESCRIPTION OF THE PREFERRED EMBODIMENTS

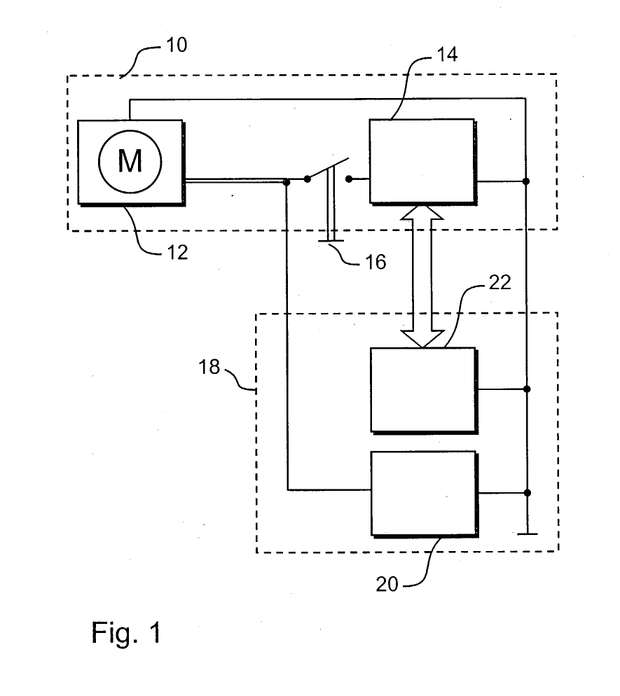

FIG. 1 shows a block diagram of a current supply device for a battery-operated screwdriver 10 in accordance with the present invention. It is driven by an electrical drive unit 12, and the electrical drive unit 12 is shown only schematically.

The control of the drive unit 10 is performed through a control unit 14 which is also shown schematically. The control unit 14 is turnable off by a switching element 16 which will be explained herein below.

The current supply of the battery-operated screwdriver 10 is performed by a battery pack 18 with a battery 20 without selfdischarge. For protection of the battery 20 during the normal operation, the battery pack 18 is provided with an electronic protection circuit 22 which prevents damages to the battery 20.

The battery pack 18 with the battery 20 and the protection circuit 22 has a housing which can be inserted in a correspondingly shaped receiving compartment in the battery-operated screwdriver 10.

Several connecting contacts can be arranged on the housing of the battery pack 18 and in the receiving compartment of the battery operated screwdriver 10 so that upon insertion of the battery pack 18 in the receiving compartment they provide an electrical contact.

A ground terminal of the battery 20 is connected with corresponding ground terminals of the protection circuit 22, the control circuit 14 and the drive unit 12. Furthermore, a current terminal of the battery 20 is connected with the corresponding current terminal of the drive unit 12. Furthermore, the current terminal of the battery 20 is connected through the switching element 16 with the current terminal of the control unit 14, so that the control unit circuit 14 can be switched on or switched off by the switching element 16. Finally, the protection circuit 22 is connected through a bus conductor with the control circuit 14, whereas the protection circuit 22 draws its operational current from the control circuit 14, so that the switching off of the control unit 14 leads indirectly also to a switching off of the protection circuit 22.

Before a long storage of the battery-operated screwdriver 10 with the battery pack 18, the consumer activates the switching element 16 so that the control unit 14 is switched off. The switching off of the control unit 14 leads to a situation that also the current supply for the protection circuit 22 is switched off, and the protection circuit 22 during the storage does not consume current. This increases the maximum possible storage time.

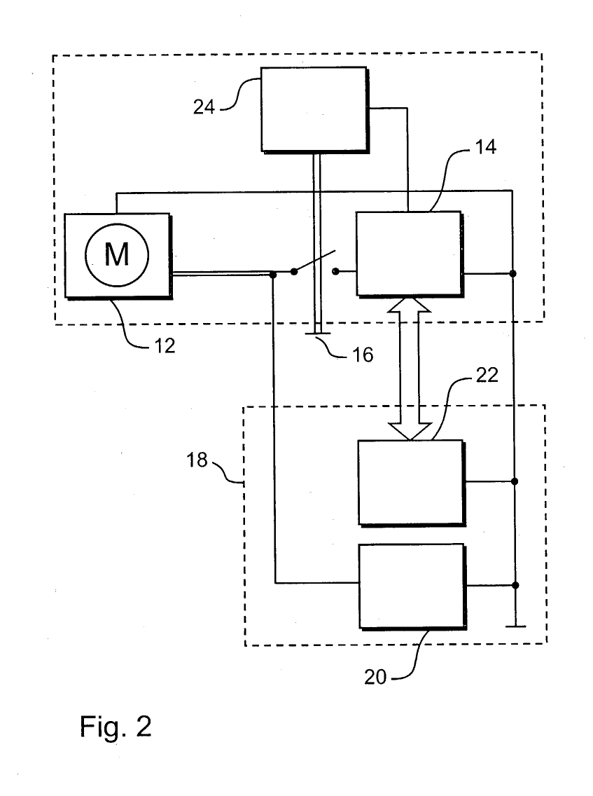

For the embodiment shown in FIG. 2, the above described operation with respect to FIG. 1 is applicable as well, and the corresponding components are identified with the same reference numerals order to avoid redundant description.

The specific features of this embodiment is that for time-controlled switching off of the control circuit 14, additionally a time switch clock 24 is provided. The time switch clock 24 acts on the switching element 16 for turning on and turning off of the latter. For controlling the switching process the time switch clock 24 has a reset input, through which the time switch clock 24 is connected with the control circuit 14. Each activation of the control circuit 14 leads to a reset of the time switch clock 24, while to the contrary the time switch clock 24 after a longer continuing inactivity of the control circuit 14 separates the switching element 16, whereby the control circuit 14 is switched off. With the switching off of the control circuit 14, the current supply for the protection circuit 22 is switched off and therefore no electrical energy is consumed. Thereby the maximum possible storage time is substantially increased.

During a further start of the electrical device 10, the consumer must then manually activate the switching element 16. Thereby the control circuit 14 and therefore the current supply for the protection circuit 22 are turned on.

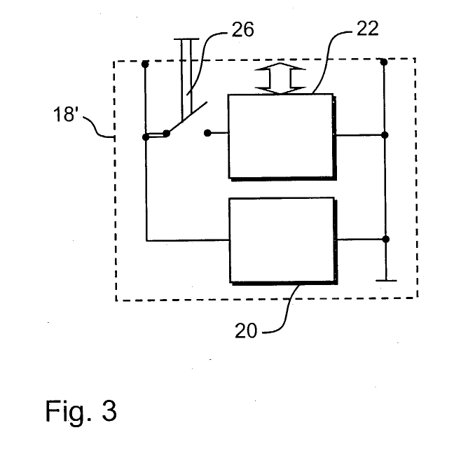

In the battery pack 18′ shown in FIG. 3, the operation substantially correspond to the operation of the battery pack 18 and the corresponding components are identified with the same reference numerals to avoid redundance of the description.

The specific features of this embodiment is that the current supply of the protection circuit 22 is carried out not via the bus conductor through the control circuit 14, but instead directly by the battery 20. For this purpose the current terminal of the battery 20 is additionally connected via a further switching element 26 with a current terminal of the protection circuit 22.

The switching element 26 is arranged in the battery pack 18 so that the consumer can operate the switching element 26 without removing the battery pack 18 from the battery-operated screwdriver 10. The consumer can activate the switching element 26 before a long storage of the battery-operated screwdriver 10 with the battery pack 18, and therefore turn off the protection circuit 22. Thereby a maximum possible storage time is substantially increased.

Moreover, the switching element 26 can be arranged in the battery pack 18, so that the switching element 26 during a withdrawal of the battery pack 18 is automatically separated and thereby the protection circuit 22 is switched off. In this way it is guaranteed that the battery pack 18 in a withdrawn condition is no longer unnecessarily discharged by the protection circuit 22.

It will be understood that each of the elements described above, or two or more together, may also find a useful application in other types of constructions differing from the types described above.

While the invention has been illustrated and described as embodied in current supply device and electrical apparatus, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A current supply device for an electrical appliance formed as a battery-operated power tool, comprising an electrical energy storage; a protection circuit for said energy storage; and a switching element for switching off said protection circuit.

2. A current supply device as defined in claim 1, wherein said switching element is directly connected with said protection circuit.

3. A current supply device as defined in claim 1; and further comprising a control circuit, said protection circuit for providing its current supply being connected to said control circuit, said switching element being connected with said control circuit for indirect switching off of said protection circuit.

4. A current supply device as defined in claim 1; and further comprising a time switch clock for automatic time-control switching off of said protection circuit.

5. A current supply device as defined in claim 4, wherein said time switch clock has a control input for connecting with said control circuit.

6. A current supply device as defined in claim 1, wherein said energy storage and said protection circuit are components of an energy storage module and have a joint housing.

7. An electrical appliance, comprising an appliance part; and a current supply device for supplying current to said appliance part and including an electrical energy storage, a protection circuit for said energy storage; and a switching element for switching off said protection circuit.

8. An electrical appliance as defined in claim 7; and further comprising an appliance housing in which said switching element for switching off said protection circuit is arranged so that said switching element is actuatable from outside of said appliance housing.

9. An electrical appliance as defined in claim 7, wherein said energy storage and said protection circuit are components of an energy storage module; and further comprising a receiving compartment in which said energy storage module is accommodated.

10. An electrical appliance as defined in claim 9, wherein said receiving compartment and said energy storage module are provided with corresponding terminal contacts which form an electrical connection between said control circuit and said protection circuit.
